(19) United States
(12) Patent Application Publication
(10) Pub. No.: US 2009/0151805 A1
(43) Pub. Date: Jun. 18, 2009

(54) BLOW-OUT PREVENTION HOSE BUNDLE FOR OFFSHORE OIL RIGS

(76) Inventors: Nick A. Martino, North Canton, OH (US); Mark G. Siber, Beachwood, OH (US); Gerald T. Edwards, Atwaer, OH (US); Michael R. Swails, Madison, OH (US)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/330,917

(22) Filed: Dec. 9, 2008

Related U.S. Application Data
(60) Provisional application No. 61/013,529, filed on Dec. 13, 2007.

(51) Int. Cl. F16L 11/00

(52) U.S. Cl. 138/125

(57) ABSTRACT

Flexible thermoplastic hose bundle for use in the operation and control of Blow-Out Prevention (BOP) valves and other devices located on subsea well heads. The bundle includes a plurality ⅛-inch inner diameter (ID) hoses which are cabled around a central hose and sheathed in an outer jacket.

### CROSS-REFERENCE TO RELATED CASES

The present application claims the benefit of the filing dates of U.S. Provisional Application Ser. Nos. 61/013,529, filed Dec. 13, 2007, and 61/051,702, filed May 9, 2008, the disclosure of each of which is expressly incorporated herein by reference.

### BACKGROUND OF THE INVENTION

The present invention relates broadly to flexible thermoplastic hose bundles, and more particularly to such bundles for use in supplying hydraulic fluid for the operation and control of Blow-Out Prevention (BOP) valves and other devices located on subsea well heads.

The offshore oil drilling and recovery industry widely uses flexible hose bundles which are termed BOP hose bundles. Such bundles conventionally are constructed as including up to 70 or more 3/16-inch inner diameter (ID) hoses which are cabled around a 1-inch (ID) central hose. The hoses so bundled then are sheathed within a surrounding cover or jacket.

In service, BOP bundles are employed, such as in the manner shown in U.S. Pat. No. 7,191,836, to extend from an above-water oil platform or rig to BOP pods or stacks provided on the undersea well heads. These well heads may reside at ocean depths of 5,000 feet or more.

Within the bundle, the central hose is used as a power line to supply hydraulic or other fluid power for operating valves in the BOP stack which are closed in the event of an oil or gas leak from the well head. The smaller hoses are used as pilot lines to transmit hydraulic signals for the control of the valves.

The offshore drilling industry has standardized on 3/16-inch (ID) thermoplastic hoses for the pilot lines. These hoses typically utilize a spiral-wound, low-elongation aramid fiber reinforcement capable of 3000 or 5000 psi working pressures with a 4 to 1 design factor. Hoses of such type are marketed by the Parflex Division of Parker-Hannifin Corp., Cleveland, Ohio, under the designations “573LH-3” and “575LH-3,” and by Eaton Corp., Mantua, Ohio, under the name “Synflex®” and the designations “37LV” and “38LV.” Hose and tubing bundles are shown, for example, in U.S. Pat. Nos. 4,684,427 and 6,711,329.

The industry trend, however, is for exploration and recovery to be performed at depths exceeding 10,000 feet. Such extreme depths dictate that the BOP hose bundles be manufactured in continuous lengths of 12,000 feet or more. Current hose designs for pilot lines are believed to be unsuitable for BOP bundles of such lengths. In this regard, signal response time is directly related to hose volumetric expansion and hose length. While the volumetric expansion and subsequent signal response time for current hose designs are acceptable for depths up to 8,000 feet, signal response times would be poor at deeper depths. As a result, rig operators have had to use more expensive and less reliable alternatives to thermoplastic hose bundles.

Moreover, BOP bundles of conventional 3/16-inch hoses are inherently limited in the number of pilot lines that may be bundled for deeper depths due to physical size limitations in manufacturing, packaging, and transport. The cost of manufacturing, packaging, and transporting a conventional BOP bundle for deeper depths may be prohibitively high.

It is anticipated, therefore, that improvements in BOP hose bundles would be well-received by the offshore oil drilling industry. Especially desired would be a flexible thermoplastic BOP hose bundle suited for deeper depths.

### BROAD STATEMENT OF THE INVENTION

The present invention is directed to flexible thermoplastic hose bundles. More particularly, the invention is directed to such bundles for use in supplying hydraulic fluid for the operation and control of Blow-Out Prevention (BOP) valves and other devices located on subsea well heads.

To maintain effective well head control at ocean depths of 10,000 feet or more, the BOP bundle construction of the present invention is designed to provide faster hydraulic signal response time at increased service pressures approaching 5000 psi, but with reduced bundle weight and envelope size, and with improved bundle flexibility. In this regard, such construction affords smaller finished hose outer diameters and lower volumetric expansion than conventional bundle designs.

In an illustrative embodiment, the flexible thermoplastic BOP hose bundle of the present invention is employed to convey fluid pressure for blowout prevention from an oil platform to an undersea wellhead. A length of a bundle as including a plurality of pilot hoses surrounding a central power hose run between the platform and the wellhead. The pilot hoses are constructed of an innermost core tube formed of one or more layers of thermoplastic polymeric materials. The core tube has an inner diameter of about ⅛-inch and is surrounded by first and second aramid or other fiber reinforcement layers which may be spiral wound. The reinforcement layers, in turn, are surrounded by an outermost jacket.

The present invention, accordingly, comprises the construction, combination of elements, and arrangement of components and steps which are exemplified in the detailed disclosure to follow. Advantages of the present invention include the ability to afford designers of BOP bundle the options of achieving: (i) a 4:1 design factor (ratio of burst pressure to working pressure) with only two spiral-wound aramid or other fiber reinforcement layers rather than the four layers typical in 5000 psi working pressure applications; (ii) longer continuous manufacturing lengths as a result of the reduction in fiber reinforcement required per lineal foot; and (iii) a finished BOP bundle that is either (a) smaller and lighter and, potentially longer than current offerings with a comparable number of individual hoses, or (b) similar in finished outer diameter (OD) size but with lower weight and a significantly higher number of hoses, or (c) similar in finished OD size and individual hose count but with a thicker overall sheath for greater bundle protection and durability. These and other advantages should be apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a side elevational, cut-away view of a representative embodiment of a flexible thermoplastic BOP hose bundle in accordance with the present invention including a number of pilot line hoses cabled around a central power line hose;

FIG. 2 is a radial cross-sectional view of the BOP hose bundle of FIG. 1 taken through line 2-2 of FIG. 1;

FIG. 3 is a side elevational, cut-away view of a representative construction for the individual pilot line hoses of the BOP hose bundle of FIG. 1;

FIG. 4 is a radial cross-sectional view of the pilot line hose of FIG. 3 taken through line 4-4 of FIG. 3; and

FIG. 5 is an anisometric schematic overview of an offshore installation of the BOP hose bundle of FIG. 1.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the illustrative purposes of the discourse to follow, the precepts of the hose bundle construction of the invention herein involved are described in connection with a representative embodiment which is adapted particularly for use in supplying hydraulic fluid for the operation and control of Blow-Out Prevention (BOP) valves and other devices located on subsea well heads. It will be appreciated, however, that aspects of the present invention may find use in other hose bundle constructions for a variety of instrumentation, control, sensing, and fluid transfer applications, such as those described, for example, in commonly-assigned U.S. Pat. No. 6,711,329. Use within those such other applications therefore should be considered to be expressly within the scope of the present invention.

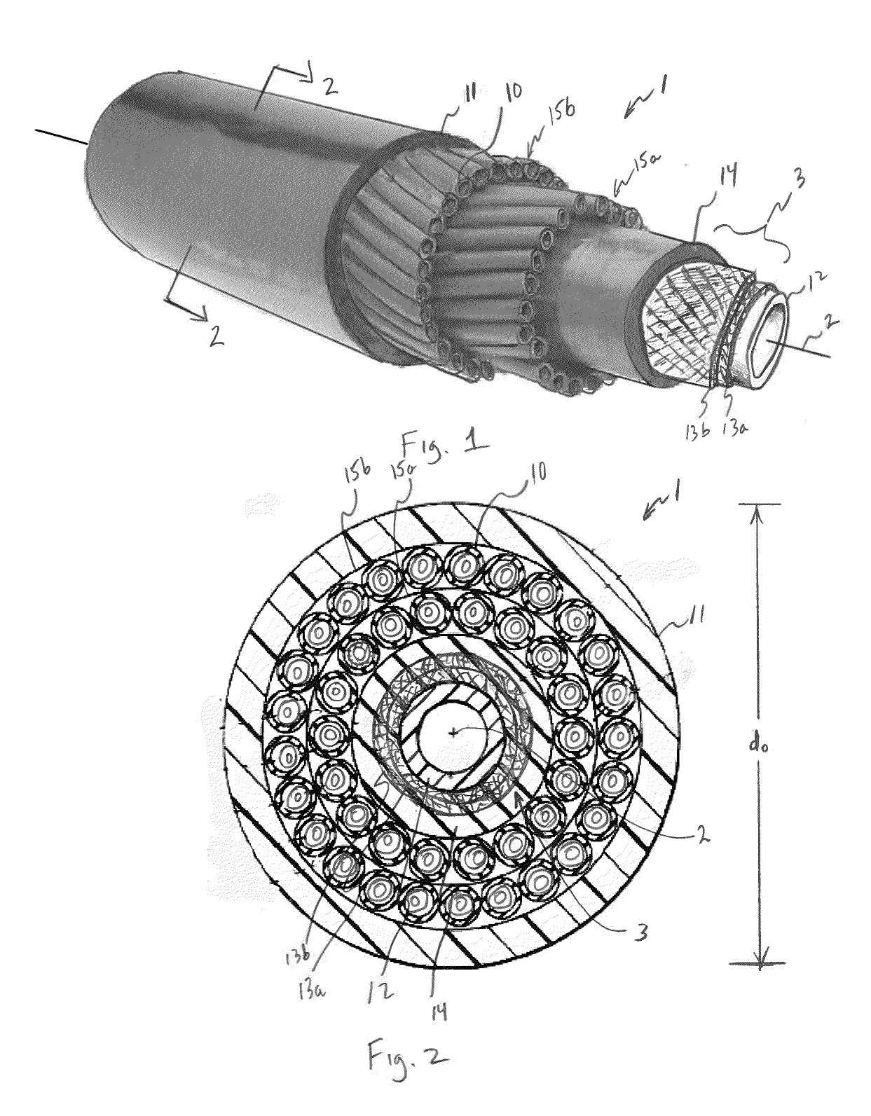

Referring then to the figures wherein corresponding reference characters are used to designate corresponding elements throughout the several views with equivalent elements being referenced with prime or sequential alphanumeric designations, a representative flexible thermoplastic hose bundle construction according to the present invention is shown generally at 1 in the cut-away view of FIG. 1 and in the radial cross-sectional view of FIG. 2. In basic dimensions, hose bundle construction 1 extends axially to an indefinite length, which may be 12,000 feet or more as wound around a reel or spool for offshore transport and deployment, along a central longitudinal axis, 2, and in a radial direction circumferentially about axis 2 in defining an outer diametric extent, referenced generally at “dₒ” in the radial cross-sectional view of FIG. 2. Such extent will vary depending upon, for example, the number of hoses in the bundle, but generally will be between about 4-5 inches.

As may be seen in the views of FIGS. 1 and 2, hose bundle construction 1 includes a central power hose, referenced generally at 3, up to 100 or more pilot hoses, one of which is referenced at 10, and a protective cover or jacket, 11.

Pilot hose 3 may be conventionally provided as a low volumetric expansion hose such as shown, for example, in commonly-assigned U.S. Pat. No. 4,699,178. Particularly hose 3 may be provided as a 1-inch ID, 2000-5000 psi-rated high pressure hose such as H580N-16 marketed by the Parflex Division of Parker-Hannifin Corporation, Ravenna, Ohio. Such hose 3 may include a nylon or other thermoplastic core tube, 12, one or more layers, 13a-b, of a braided or spiral-wound aramid, polyester, or other fiber reinforcement, and a protective outer jacket, 14, which may be formed of an abrasion-resistant thermoplastic polyurethane.

The pilot hoses 10 are arranged, such as in two or more rows, 15a-b, radially around the pilot hose 3. In such arrangement, each of the hoses 10 extends longitudinally along axis 2 generally parallel to each of the other hoses 10, and is abutted in each row 15 against an adjacent hose. As may be seen in the cut-away view of FIG. 1, the hoses 10 may be “cabled” such that each row 15 exhibits a slight, i.e., 0.15-2.5 turns per foot, helical twist or spiral relative to axis 2. Such cabling of the row 15a-b is preferred to better resist the sagging of any one of the constituent hoses 10 below any of the other hoses.

The hoses 3 and 10 are contained within the jacket 11 which may be the outermost layer of the bundle 1. Jacket 11 may be extruded or otherwise formed in one or more layers over the outermost row 15b of the hoses 10. Suitable materials for forming the one or more layers of the jacket 11 include abrasion-resistant thermoplastic materials such as polyurethanes, polyamides, polyolefins, silicones, polyesters, fluoropolymers, polyvinyl chlorides, and copolymers and blends thereof. Theses materials may be unfilled or filled with a fiber, glass, ceramic, or other filler. By “abrasion-resistant,” it is meant that such thermoplastic material for forming one or more of the layers of jacket 11 may have a hardness of between about 60-95 Shore A durometer. Depending upon the applications, the one or more layers of the jacket 11 may have an overall thickness of between about ¼-¾ inch.

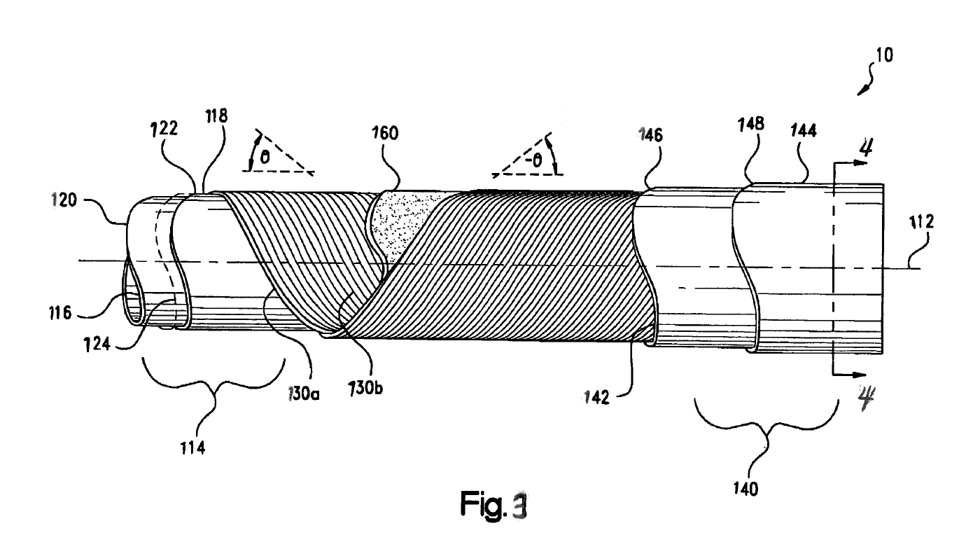

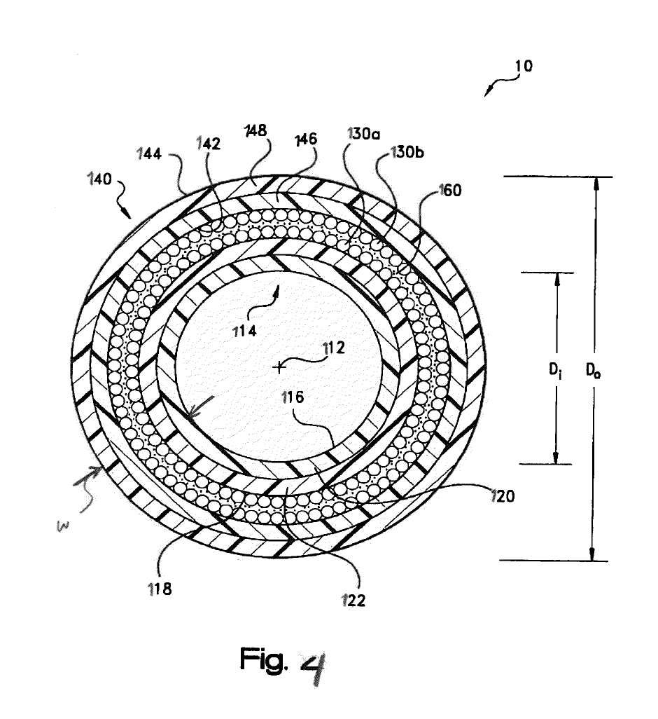

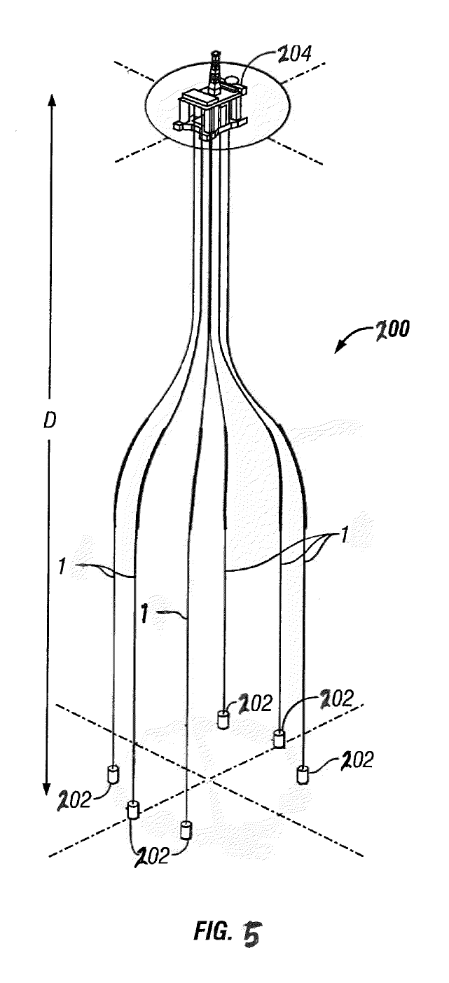

Looking next to FIGS. 3 and 4, a pilot hose in accordance with the present invention reappears at 10 in the cut-away view of FIG. 3 and in the radial cross-sectional view of FIG. 4. In basic dimensions, hose 10 extends axially in the bundle 1 of FIGS. 1 and 2 to an indefinite length along a central longitudinal axis, 112, and has a select inner and outer diameter referenced, respectively, at “Dᵢ” and “Dₒ” in the radial cross-sectional view of FIG. 3. With the inner diameter dimension Dᵢ selected in accordance with the invention to be about ⅛-inch, the outer diameter dimension Dₒ may vary depending upon the application, but typically may be between about 0.300-0.325 inch, with a overall wall thickness, referenced at “w” in FIG. 4, therebetween of between about 0.0875-0.100 inch.

As may be seen in the views of FIGS. 3 and 4, hose 10 is constructed as being formed about a tubular core, referenced at 114. Conventionally, core tube 114 may be provided as extruded from a thermoplastic material, such as a polyolefin, polyester, fluoropolymer, polyvinyl chloride, ethylene vinyl alcohol (EVA), polyacetal, polyoxymethylene (POM), silicone, thermoplastic rubber, polyurethane, or a polyamide such as Nylon 6, 6/66, 11, 12, or 6/12, which may be selected for chemical compatibility with the fluid being handled. Alternatively, core tube 14 may be extruded of a vulcanizable, i.e., thermosetting, or melt-processible, i.e., thermoplastic, natural or synthetic rubber such as SBR, polybutadiene, EPDM, butyl, neoprene, nitrile, polyisoprene, buna-N, copolymer rubber, or a blend such as ethylene-propylene rubber. Core tube 114 has a circumferential inner core tube surface, 116, defining the about ⅛-inch inner diameter Dᵢ of the hose 10, and a circumferential outer core tube surface, 118. As with the overall dimensions of hose 10, the wall thickness of core tube 14 may vary for the particular application envisioned, but typically will be between about 0.02-0.12 inch (0.51-3.1 mm).

Although core tube 14 may be formed of a unitary, single-layer construction, it is preferred for many applications that the core tube 114 be provided, as shown, as having a composite, multi-layer construction. In such multi-layer construction, core tube 114 includes an innermost layer or liner, 120, which defines the inner core tube surface 116, and an outermost layer, 122, which defines the outer core tube surface 18. For chemical resistance, innermost layer 120 may be provided as extruded or otherwise formed of a melt-processible thermoplastic which may be a fluoropolymer, polyamide, or co-polyester. As used herein, “chemical resistance” should be understood to mean the ability to resist swelling, crazing, stress cracking, corrosion, or otherwise to withstand attack from mild acidic or alkaline solutions, phosphate-ester solutions, and alcohols and other organic solvents and hydrocarbons, as well as inorganic solvents such as water or brine. Preferred fluoropolymers include polytetrafluoroethylene (PTFE), fluorinated ethylene polypropylene (FEP) copolymer, perfluoroalkoxy (PFA) resin, polychlorotrifluoroethylene (PCTFE) copolymer, ethylene-chlorotrifluoroethylene (ECTFE) copolymer, ethylene-tetrafluoroethylene (ETFE) terpolymer, polyvinylidene fluoride (PVDF), polyvinylfluoride (PVF), and copolymers and blends thereof. For cost considerations, the wall thickness of innermost layer 120 may be maintained at the minimum necessary to provide the desired solvent, gas, or liquid permeation resistance, and for most applications may be between about 2-30 mils (0.05-0.76 mm).

Outermost layer 122, in turn, is provided as being formed of a relatively flexible polymeric material which may be thermoplastic or otherwise melt-processible or, alternatively, vulcanizable or otherwise cross-linkable or thermosetting. Such material specifically may be selected for flexibility, that is, as having a lower flexural modulus than that of the material forming innermost layer 120, or otherwise for temperature performance and/or compatibility with the core tube 114. Suitable materials include plastics such as polyamides, polyesters, polyurethanes, polyolefins, polyvinyl chlorides, polyacetals, ethylene vinyl alcohols, polyoxymethylenes, natural rubbers such as Hevea and thermoplastic, i.e., melt-processible, or thermosetting, i.e., vulcanizable, synthetic rubbers such as fluoropolymer, chlorosulfonate, polybutadiene, butyl, neoprene, nitrile, polyisoprene, and buna-N, copolymer rubbers such as ethylene-propylene (EPR), ethylene-propylene-diene monomer (EPDM), nitrile-butadiene (NBR) and styrene-butadiene (SBR), or blends such as ethylene or propylene-EPDM, EPR, or NBR, and copolymers and blends of any of the foregoing. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

Preferably, outermost layer 122 is formed of a material which is compatible with or otherwise bondable directly to the innermost layer 120. Alternatively the two layers may be bonded, if incompatible, means of a tie layer in a manner to be described hereinafter. For strength and flexibility considerations, the wall thickness of outermost layer 122 may be thicker than that of innermost layer 120, and typically will range from about 15 mils (0.38 mm) to about 110 mils (2.8 mm). High flexural modulus resin for core tube to increase hoop strength and resistance to expansion and elongation. Particularly preferred materials for forming each or any of the layers 120 or 122, or any additional layers therebetween, will have a flexural modulus of at least about 65,000 psi and up to 100,000 psi or higher, such as unplasticized nylon 6, 11, or 12, which may be unfilled or glass-filled.

Core layers 120 and 122 may be fabricated by extrusion, co-extrusion, or sequential extrusion and, if formed of compatible materials, thereby cross-linked or otherwise chemically or fusion bonded together at their interface into an integral, tubular composite structure. If formed of chemically dissimilar or otherwise incompatible materials, however, an adhesion-promoting surface treatment may be applied or an intermediate tie or bonding layer, shown in phantom at 124 in FIG. 3, may be co-extruded, i.e., “tri-extruded,” with layers 120 and 122, or sequentially extruded or over-coated therebetween, as being formed of a material which is adhesion bond compatible with both the materials of layers 120 and 122. Preferably, intermediate layer 124 is formed of material which also is resistant to solvent permeation, and which generally is more elastic than the material forming layer 120. Suitable materials include PVDF, PVF, polyvinyl acetate (PVA), methyl acrylics, urethanes, polyvinyl chlorides, polyolefins, and copolymers, alloys, and blends thereof, as well as thermoplastic or thermosetting rubbers. The wall thickness of intermediate layer typically will be less than or about equal to the wall thickness of inner layer 120. Composite tubes of the type herein involved are further described in U.S. Pat. Nos. 3,561,493; 5,076,329; 5,167,259; 5,284,184; 5,383,087; 5,419,374; 5,460,771; 5,469,892; 5,500,257; 5,554,425; 5,566,720; 5,622,210; 5,678,611; and 5,743,304, and are marketed commercially by ITT Automotive, Inc. (Auburn Hills, Mich.) and by Pilot Industries, Inc. (Dexter, Mich.).

With respect to the spiral-wound construction shown in FIGS. 3 and 4, preferably two as is shown, and up to eight or more, reinforcement layers, 130a-b, are provided over the core tube 114. Each of the reinforcement layers 130 may be conventionally formed as spiral, i.e., helically, wound of, for example, from 1 to about 60 ends of monofilament, continuous multi-filament, i.e., yarn, stranded, cord, roving, thread, tape, or ply, or short “staple” strands of a fiber material. The fiber material, which may be the same or different in layers 130a-b, may be a natural or synthetic polymeric material such as a nylon, cotton, polyester, polyamide, aramid, para-aramid, polyolefin, polyvinyl alcohol (PVA), polyvinyl acetate, polyphenylene bezobisoxazole (PBO), liquid crystal copolymer, a steel, which may be stainless or galvanized, brass, zinc or zinc-plated, or other metal or alloy wire, or a bi, tri- or multi-component blend thereof.

In the illustrated spiral wound construction 10 of FIGS. 3 and 4, which also may contain additional braided and/or knitted layers (not shown), the reinforcement layers 130 are oppositely wound in pairs so as to counterbalance torsional twisting effects. For each of the spiral wound layers 130a-b, from 1 to about 60 parallel ends of, preferably, multi-filament aramid or para-aramid yarn having a denier of between about 500-3000, such as DuPont Kevlar® 956, may be helically wound under tension in one direction, i.e., either left or right hand, with the next immediately succeeding layer 130 being wound in the opposite direction. Other yarns having lower elongation, equal or higher tenacity, and higher modulus, such as DuPont Kevlar® 965, 965A, or 956C, or Teijin Aramid Twaron® D2200 may also be used for reduced volumetric expansion and response times. Generally such yarns having an elongation at break of less than about 3%, a breaking tenacity of at least about 20 gpd, and an initial modulus of at least about 100 GPa may be specified. The layers 130a-b may be wound as is shown in FIG. 3 directly over the outer surface 118 of core 114, or, alternatively, over one or more intervening reinforcement layers, as having a predetermined pitched angle, referenced at θ in FIG. 3 for layer 130a and at −θ for layer 130b, measured relative to the longitudinal axis 12 of the hose 10. The layers further may be wound with the yarn or other end having a clockwise or counterclockwise twist of between 0 and about 2 turns per centimeter which may be imparted as supplied by the manufacturer, i.e., manufacturer's twist, or as is imparted as the ends are spooled. As is known in the art, the twist may be varied to optimize for example, the flexural fatigue and/or pressure resistance of the hose or to minimize the hose diameter or cost.

For typical applications, the pitch angle θ will be selected to be between about 40-65°, but particularly may be selected depending upon the desired convergence of strength, elongation, weight, and volumetric expansion characteristics of hose 10. In general, higher pitch angles above about 54.7° exhibit decreased radial expansion of the hose under pressure, but increased axial elongation. For high pressure applications, a “neutral” pitch angle of about 54.7° generally is preferred as minimizing elongation to about ±5% of the original hose length, and preferably between about −2% and +5% as excessive negative change in length is known to adversely affect response time. Each of the layers 130 may be wound at the same or different absolute pitch angle, and it is known that the pitch angles of respective reinforcement layers may be varied to affect the physical properties of the hose. In a preferred construction, however, the pitch angles of reinforcement layers 130a-b are provided to about the same, but as reversed in successive layers.

The tension and area coverage at which the reinforcement layers 130 are braided, wound, or knitted may be varied to achieve the desired flexibility, which may be measured by bend radius, flexural forces, or the like, of the hose 10. For the spiral wound layers 130a-b depicted in FIGS. 3 and 4, the constituent yarns or other ends generally will be applied at or near about 100% coverage such that substantially no space or interstitial area exists between each successive turn, and under a relatively high tension of between about 2-7 lbs per end in a dynamic condition. In the case of a yarn, cord, roving, or other stranded fiber, such wetting also may be controlled by the twist thereof, which preferably is a “Z” or “S” twist of between about 0.15-3.5 turns per inch (0.6-1.38 turns per cm) of length.

To better control the elongation and contraction of hose 10, and for improved impulse fatigue life, the innermost reinforcement layer 130a may be bonded, by means of fusion, mechanical, chemical, or adhesive bonding, or a combination thereof or otherwise, to the outer circumferential outer surface 118 of the core tube 114. Preferably such bond will exhibit a strength of at least about 4 pli (pounds per linear inch) (0.72 kg/linear cm), and may be effected by solvating, tackifying, or plasticizing the core tube outer surface 118 with an appropriate solvent, such as a carboxylic or other organic acid, tackifier, or plasticizer such as an aqueous or other solution of a base n-methyl pyrrolidone, methyl ethyl ketone, an acetate such as ethyl or vinyl acetate, or a phenol such as meta-cresol or resorcinol and cross or other linkages which may be polydiisocyanate, epoxide, or amine-functional based, or with the use of a urethane, epoxy, vinyl chloride, methyl acrylic, or other adhesive having an affinity to the materials forming tube 114 and layer 130a, or otherwise in the manner described, for example, in U.S. Pat. Nos. 3,654,967; 3,682,201; 3,773,089; 3,790,419; 3,861,973; 3,881,975; 3,905,398; 3,914,146; 3,982,982; 3,988,188; 4,007,070; 4,064,913; 4,343,333; 4,898,212; and in Japanese (Kokai) Publ. No. 10-169854 A2 and Canadian Patent No. 973,074.

The outermost reinforcement layer 130b, in turn, may be sheathed within one or more layers of a coaxially-surrounding protective cover or jacket, referenced at 140, having a circumferential interior surface, 142, and an opposing circumferential exterior surface, 144. Depending upon its construction, cover 140 may be spray-applied, dip coated, cross-head or co-extruded, or otherwise conventionally extruded, spiral or longitudinally, i.e., “cigarette,” wrapped, or braided over the reinforcement layer 130b as, for example, a 0.02-0.15 inch (0.5-3.8 mm) thick layer of an abrasion-resistant, preferably melt-processible, thermoplastic material, copolymer, alloy, or blend of a fiber, glass, ceramic, or metal-filled or unfilled polyamide, polyolefin, polyester, polyvinyl chloride, fluoropolymer, thermoplastic rubber (TPR), thermoplastic elastomer (TPE), thermoplastic olefin (TPO), or, most preferably, a thermoplastic polyurethane (TPU) elastomer. By “abrasion-resistant,” it is meant that such thermoplastic material for forming cover 30 may have a hardness of between about 60-98 Shore A durometer. As with core 114, cover 140 alternatively may be formed of a vulcanizable natural or synthetic rubber such as SBR, polybutadiene, EPDM, butyl, neoprene, nitrile, polyisoprene, silicone, fluorosilicone, buna-N, copolymer rubbers, or blends such as ethylene-propylene rubber. Any of these materials forming cover 60 may be loaded with metal particles, carbon black, or another electrically-conductive particulate, flake, or fiber filler so as to render hose 10 electrically-conductive for static dissipation or other applications. Separate electrically-conductive fiber or resin layers (not shown), which may be in the form of spiral or “cigarette-wrapped” tapes or otherwise provided, also may be included in the hose construction 10 between the core 114 and the innermost reinforcement layer 130a, between the reinforcement layers 130, or between the outermost reinforcement layer 130b and cover 140.

Similar to the bonding of core 114 to the innermost reinforcement layer 130a, the interior surface 142 of cover 140 may be bonded to the outermost reinforcement layer 130b. Such bond, again, may be by fusion, chemical, mechanical, or adhesive means, or a combination thereof or other means, and preferably will exhibit a strength of at least about 8 pli (1.43 kg/linear cm). As before, the bond may be effected by solvating, tackifying, or plasticizing the surface of the outermost reinforcement layer 130b with an appropriate solvent, such as a carboxylic or other organic acid, tackifier, or plasticizer such as an aqueous or other solution of an amine such as n-methyl pyrrolidone or a phenol such as meta-cresol or resorcinol, or with the use of a urethane or other adhesive having an affinity to the materials forming reinforcement layer 130b and cover 140, or otherwise in the manner described in the above-cited references or in the manner to be described in connection with the bonding between layers 130a-b.

In the illustrative multi-layer construction of cover 140 shown in FIGS. 3 and 4, cover 140 is provided as having an innermost cover layer, 146, which is formed of a first, preferably, thermoplastic material and which defines the interior cover surface 142, and a surrounding outermost cover layer, 148, which is formed of a second, preferably, thermoplastic material and which defines the exterior cover surface 144. Depending upon the application, the relative thicknesses of the layers 146 and 148 may be different or about the same. However, to further enhance the flexibility of hose 10, the first thermoplastic material forming the innermost cover layer 146 may be selected has having a flexural modulus which is lower than the flexural modulus of the outermost cover layer 148. In this way, the thickness of the less flexible outermost cover layer 48 may be decreased as compared to a single layer construction of cover 140. Although many combinations of materials may be used, the first thermoplastic material forming the more flexible innermost layer 146 may be a polyamide, polyolefin, polyester, EVA, TPO, TPE, TPU, TPR, fluoroelastomer or other fluoropolymer, polyvinyl chloride, silicone, polyurethane, a natural or synthetic rubber, or a copolymer of blend thereof, with the second material being, independently, a less flexible but harder, i.e., at least about 60 Shore A durometer, filled or unfilled polyamide, polyurethane, polyester, polyolefin, fluoropolymer, TPE, ionomer resin such as “Surlyn®” (DuPont, Wilmington, Del.), or a copolymer or blend thereof. If formed of chemically compatible thermoplastic materials, the respective layers 44 and 46 may be fusion bonded together at their interface. Alternatively, if formed of chemically incompatible materials, the respective layers 44 and 46 may be bonded together with an adhesive or by means of a surface treatment or tie layer (not shown) interposed therebetween.

Returning to FIGS. 3 and 4, each of the reinforcement layers, such as layer 130a, within hose 10 is bonded, typically chemically and also, in most instances, mechanically, to its immediately succeeding layer, such as layer 130b, so as to provide for the more efficient transfer of induced internal or external stresses. By “chemically bonded,” it is meant that the layers are bonded together, such as by fusion or cross-linking, directly or indirectly through an intermediate adhesive, resin, or other interlayer, as referenced at 160 in FIGS. 3 and 4, such that atoms of the materials forming the reinforcement layers 30a-b are bonded to atoms of the other layer 130a or 130b or to atoms of the material forming interlayer 160. The chemical bond may be either covalent, ionic, or hydridic, i.e., hydrogen, bridge bonding, and results, along with any mechanical bonding, in the formation of an integral reinforcement structure exhibiting, for example, an interlayer bond, i.e., 270° peel strength per ASTM D413-98, “Standard Test Methods for Rubber Property-Adhesion to Flexible Substrates,” of at least about 6.0 pli (1.07 kg/linear cm). However, in accordance with the precepts of the present invention, the radial penetration or other “wetting” of the individual filaments of the fibers forming the reinforcement layers 130 by the applied liquid form of a bonding agent, which may be an adhesive, resin, plasticizer, tackifier, solvent, or the like, is minimized or otherwise controlled such that substantially only the surface filaments or other portion of the filaments of those fibers are contacted by the bonding agent. In this way, the remainder of the filaments are not bound and thereby remain free to elongate or otherwise flex in affording optimum and consistent stress distribution. Typically, the wetted portion of the filaments will be a minor portion of the reinforcement fibers, i.e., between about 0.5-20% by either a total weight, filament number, or volume average, with the major portion being the unwetted balance.

In an illustrative embodiment, the bonding agent is provided as an adhesive in the form of a melt-processible or vulcanizable material which is extruded or otherwise applied in a molten, softened, or otherwise flowable phase over the reinforcement layer 130a to form the interlayer referenced at 160 in FIGS. 3 and 4 which may have a thickness of between about 1-25 mils (0.025-0.64 mm). The reinforcement layer 130b then may be wound over the interlayer 160 while it is still in its softened phase. Alternatively in the case of a thermoplastic interlayer 160, the layer may be reheated to effect its re-softening prior to the winding of reinforcement layer 130b. “Soften” is used herein in its broadest sense to indicate a transition from a form-stable crystalline or glassy solid phase to a flowable liquid, semi-liquid, or otherwise viscous phase which may be generally characterized as exhibiting intermolecular chain rotation. For any number of reinforcement layers 130 provided in the construction of hose 10, a separate interlayer 60 may be interposed between each layer 130 and each successive layer 30 to effect a bond in accordance with the present invention therebetween.

The material forming interlayer 160 specifically may be selected for high temperature performance, flexibility, or otherwise for compatibility with the reinforcement layers 130. Suitable materials include natural rubbers such as Hevea and thermoplastic, i.e., melt-processible, or thermosetting, i.e., vulcanizable, resins which should be understood to also include, broadly, materials which may be classified as elastomers or hot-melts. Representative resins include plasticized or unplasticized polyamides such as nylon 6, 66, 11 and 12, polyesters, copolyesters, ethylene vinyl acetates, polybutylene or polyethylene terephthalates, polyvinyl chlorides, polyolefins, fluoropolymers, thermoplastic elastomers, thermoplastic hot-melts, copolymer rubbers, blends such as ethylene or propylene-EPDM, EPR, or NBR, polyurethanes, and silicones. In the case of thermoplastic resins, such resins typically will exhibit softening or melting points, i.e., Vicat temperatures, of between about 77-250° C. For amorphous or other thermoplastic resins not having a clearly defined melting peak, the term melting point also is used interchangeably with glass transition point.

Depending upon the composition of the layers 130a-b vis-à-vis that of interlayer 160, the material forming interlayer 160 may be modified with between about 0.1-15.0% by total weight of an adhesion promoter such as maleic anhydride, methylmethacrylate, poly-hydroxystyrene, or a blend, alloy, or mixture thereof. Such promoter assists in the formation of chemical bonds between the layers, and, in the case of thermoplastic resin materials, increases temperature resistance without a corresponding increase in flexural modulus. Similar treatments also may be applied to the fiber materials forming the reinforcement layers 130. Such treatments, and as is described further in International (PCT) Publ. No. WO 95/22576, may involve an adhesive system which comprises an isocyanate and one or more polyunsaturated heteroatom polymers. Alternatively, a more conventional resorcinol-formaldehyde-latex (RFL) treatment may be employed.

The material forming interlayer 160, or in one or more of the interlayers 160 which may be near or spaced-apart from the core tube 114 in a construction 10 having more than two reinforcement layers 130, also may be loaded with metal particles, carbon black, or another electrically-conductive filler so as to render hose 10 electrically-conductive for static dissipation or other applications. Conversely, by selection of a hydrophobic fiber for the reinforcement layers 130a-b and the use of a resin as the bonding agent therefor, an electrically non-conductive spiral wound or other hose construction may be produced.

Interlayer 160 alternatively may be provided as a co-extrusion, laminate, or other composite system formed of two or more successive layers with each of the layers formed of a different resin selected, for example, as being compatible with or otherwise having an affinity to an adjacent reinforcement layer 130. In this way, reinforcement layers 130a-b which are formed of materials having differing chemical compositions effectively may be joined across a composite interlayer 160. If the different resins within the respective layers of the composite interlayer 160 are themselves incompatible, one or more intermediate tie layers formed of one or more compatibilizing resins may be provided between the incompatible resin layers to effect a bond across the entirety of the interlayer 160. Representative examples of a two-layer resin system for interlayer 160 include polyvinyl chloride-polyester, polyamide-polyurethane, polyester and copolyester-urethane, polyvinylidene fluoride-polyurethane, and polyolefin-polyester combinations. Each of the resins within the respective layers of the composite interlayer 60 may compounded with an adhesion promoter or otherwise filled or modified in the manner described hereinbefore.

In an alternative embodiment, a conventional moisture cure urethane, or an epoxy, silicone, or other adhesive may be substituted for the resin forming interlayer 160. In another alternative embodiment, the reinforcement layers 130 may be bonded together directly by solvating, plasticizing, or tackifying the filaments of the fibers forming the reinforcements layers 130. In such alternative embodiment, the bonding agent may be provided as a solvent, such as an organic acid, or as an aqueous or other solution of a tackifier or plasticizer which may be an amine such as n-methyl pyrrolidone or a phenol such as meta-cresol or resorcinol. The solution may be coated over the reinforcement layer 130a, such as by passing the hose carcass through a bath thereof. With a reinforcement layer 130a thus being softened, the reinforcement layer 130b then may be wound thereon to bond the two layers, such as by fusion, into an integral structure, with the layer 130b likewise being softened by a film of the plasticizer, solvent, or tackifier which may be adherent on the reinforcement layer 130a.

Although the illustrative hose 10 has been described wherein two spiral wound reinforcement layers 30 are employed, other constructions may be envisioned based upon the disclose contained herein. For example, and as was mentioned, the spiral wound layers 130 may be used in combination with one or more braided and/or knitted layers, which may be formed of natural, synthetic, or metal fiber, depending upon the specific requirements of the particular application involved. Hose constructions of the type herein involved are further described in commonly-assigned U.S. Pat. Nos. 4,699,178; 6,776,195; and 6,807,988.

In providing the individual pilot hoses 10 as having ⅛-inch inner diameter rather the a conventional 3/16-inch inner diameter, and otherwise as described, faster hydraulic signal response times along the length of the hose 10 may be achieved at higher pressures length allowing for the use in service of longer length hoses at deeper ocean depths. The designer, moreover, is afforded the options of: (i) a 4:1 design factor (ratio of burst pressure to working pressure) with only two spiral-wound aramid or other fiber reinforcement layers rather than the four layers typical in 5000 psi working pressure applications; (ii) longer continuous manufacturing lengths as a result of the reduction in fiber reinforcement required per lineal foot; and (iii) a finished BOP bundle that is either (a) smaller and lighter and, potentially longer than current offerings with a comparable number of individual hoses, or (b) similar in finished outer diameter (OD) size but with lower weight and a significantly higher number of hoses, or (c) similar in finished OD size and individual hose count but with a thicker overall sheath for greater bundle protection and durability. The table below illustrates some of these design options as compared to a conventional (69 pilot lines) BOP bundle:

TABLE

| Number | Jacket | Pilot | | | Bundle | Max Reel |
|---|---|---|---|---|---|---|
| Of Pilots | Thickness | Hose OD | Center Line | Bundle OD | Wt/Ft (Lbs) | Footage² |
| 69 | 0.25″ | 0.390″ | H580N-16¹ | 4.6″ | 5.4 | 7,000 ft |
| 72 | 0.25″ | 0.315″ | H580N-16 | 3.97″ | 4 | 9,400 ft |
| 72 | 0.565″ | 0.315″ | H580N-16 | 4.6″ | 6.1 | 7,000 ft |
| 102 | 0.25″ | 0.315″ | H580N-16 | 4.6″ | 5.16 | 7,000 ft |

¹Parker Parflex Division, Ravenna, OH
²On a standard 144″ × 168″ × 60″ steel reel

Looking lastly to FIG. 5, the use of hose bundle 1 in the operation and control of BOP valves and other devices is illustrated in connection with the subsea well system depicted generally at 200. Within system 200, a number of subsea well heads, commonly referenced at 202, are connected to a floating or other oil platform, 204, by way of a corresponding number of bundles 1. The system 200 may be operated were the well heads 202 reside at an ocean depths, referenced at “D,” of 10,000 feet or deeper.

Thus, an illustrative flexible thermoplastic hose bundle is described which is particularly adapted for use in supplying hydraulic fluid for the operation and control of Blow-Out Prevention (BOP) valves and other devices located on subsea well heads.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A method of conveying a fluid under a service pressure for blowout prevention from an oil platform to an undersea wellhead comprising the steps of:
(a) providing a length of a flexible hose bundle comprising a plurality of pilot hoses surrounding a central power hose, each of the pilot hoses comprising:
an innermost core tube comprising one or more layers formed of a thermoplastic polymeric material, the core tube having an inner diameter of about ⅛-inch;
a first reinforcement layer surrounding the core tube comprising one or more filaments of a first fiber;
a second reinforcement layer surrounding the first reinforcement layer comprising one or more filaments of a second fiber; and
an outermost jacket surrounding the second reinforcement layer comprising one or more filaments of a second fiber the same as or different than the first fiber;
(b) running the length of hose bundle of step (a) between the platform and the wellhead.

2. The method of claim 1 wherein:
the filaments of the first fiber of the first reinforcement layer are spiral wound in a first winding direction; and
the filaments of the second fiber of the second reinforcement layer are spiral wound in a second winding direction opposite the first winding direction.

3. The method of claim 1 wherein the first and the second fiber each is selected, independently, from the group consisting of synthetic mono or multi-filament fibers, metal and metal alloy mono or multi-filament wires, and combinations and blends thereof.

4. The method of claim 1 wherein the first fiber and the second fiber each is selected, independently, from the group consisting of nylon fibers, polyester fibers, aramid or para-aramid fibers, liquid crystal copolymer fibers, polyvinyl alcohol fibers, polyvinyl acetate fibers, polyolefin fibers, polyphenylene bezobisoxazole fibers, metal and metal alloy wires, and combinations and blends thereof.

5. The method of claim 1 wherein the first and second fiber each is selected, independently, as having an elongation at break of less than about 3%, a breaking tenacity of at least about 20 gpd, and an initial modulus of at least about 100 GPa.

6. The method of claim 1 wherein:
each of the hoses has a central longitudinal axis;
the filaments of the first fiber of the first reinforcement layer are laid at one of a positive angle or a negative angle relative to the longitudinal axis; and
the filaments of the second fiber of the second reinforcement layer are laid at the other of the positive or negative angle relative to the longitudinal axis.

7. The method of claim 1 wherein the positive angle and the negative angle are selected such that the change in the length of the hose under the service pressure is between about −2% and +5%.

8. The method of claim 1 wherein the thermoplastic polymeric material forming each of the one or more layers of the core tube is selected, independently, from the group consisting of polyamides, polyesters, polyacetals, ethylene vinyl alcohol, polyoxymethylene, polyolefins, silicones, fluoropolymers, polyvinyl chlorides, polyurethanes, natural and synthetic rubbers, and copolymers and blends thereof.

9. The method of claim 1 wherein the thermoplastic polymeric material forming each of the one or more layers of the core tube is selected, independently, as having a flexural modulus of at least about 65,000 psi.

10. The method of claim 1 wherein each of the pilot hoses has an outer diameter between about 0.300-0.325 inch.

11. The method of claim 1 wherein the jacket is formed of one or more layers of a polymeric material selected, independently, from the group consisting of polyurethanes, polyamides, polyolefins, silicones, polyesters, fluoropolymers, polyvinyl chlorides, and copolymers and blends thereof.

12. The method of claim 1 wherein the second reinforcement layer is bonded to the first reinforcement layer.
